(19) United States
(12) Patent Application Publication
(10) Pub. No.: US 2024/0180776 A1
(43) Pub. Date: Jun. 6, 2024

(54) VIBRATION DEVICE

(71) Applicant: FOSTER ELECTRIC COMPANY, LIMITED, Tokyo (JP)

(72) Inventor: Masayuki Shibata, Akishima-shi, Tokyo (JP)

(21) Appl. No.: 18/284,857

(22) PCT Filed: Mar. 24, 2022
(86) PCT No.: PCT/JP2022/014167

§ 371 Date: Sep. 28, 2023

(30) Foreign Application Priority Data
Mar. 30, 2021 (JP) 2021-057387

(51) Int. Cl. A61H 23/02; H02K 33/18; H02P 25/034

(52) U.S. Cl. CPC A61H 23/0218; H02K 33/18; H02P 25/034; A61H 2201/1207; A61H 2201/5005

(57) ABSTRACT

A vibration device includes a voice coil type actuator that applies vibration to a human body, and a control unit that outputs a control signal, which is a composite wave obtained by combining plural sine waves having different frequencies so as to vibrate the voice coil type actuator in a vibration direction and in which a difference between frequencies of the plural sine waves is a specific frequency, to the voice coil type actuator.

### TECHNICAL FIELD

The technology of the present disclosure relates to a vibration device.

### BACKGROUND ART

Conventionally, a massager using an actuator of an electromagnetic solenoid or a piezoelectric body has been known (Japanese Patent Application Laid-Open (JP-A) No. H11-332938 and Japanese Patent Application Laid-open (JP-A) No. 2000-5257).

For example, JP-A No. H11-332938 discloses a massage machine including a hitting member that hits a site to be treated, an electromagnetic solenoid including a plunger and a solenoid to which the hitting member is connected, and a drive control unit that controls energization to the solenoid, in which a striking force detection unit that detects a striking force by the hitting member, and the energization to the solenoid is controlled according to an output of the striking force detection unit.

In JP-A No. 2000-5257, a low-frequency AC voltage is applied to a polarized piezoelectric body to vibrate the piezoelectric body to massage an affected area.

### SUMMARY OF INVENTION

### Technical Problem

Here, in music therapy, it is known that sound is made at different frequencies by left and right headphones, and a frequency of electroencephalogram is reproduced by the difference, thereby generating effects of relaxation and concentration.

In a case where vibration is applied to a human body, vibration in a low wave range, which is a frequency range of electroencephalogram, is required to obtain a similar effect of relaxation and concentration. However, since there is no vibrating body having a low resonance frequency, it is physically difficult to apply vibration in a low frequency range.

In view of the above fact, an object of the technology of the present disclosure is to provide a vibration device capable of giving comfortable vibration to a human body.

### Solution to Problem

According to one aspect of the present disclosure, there is provided a vibration device including: a vibrating body that applies vibration to a human body; and a control unit that outputs a control signal to the vibrating body so as to vibrate the vibrating body according to the control signal, the control signal being a composite wave obtained by combining a plurality of sine waves having different frequencies, and a difference between frequencies of the plurality of sine waves being a specific frequency. Here, the vibration direction of the vibrating body includes, for example, a direction substantially parallel to a contact surface with the human body, a direction substantially perpendicular to the contact surface with the human body, and the like. The vibration direction is not limited to these directions.

### Advantageous Effects of Invention

According to one aspect of the present disclosure, comfortable vibration can be given to a human body.

### BRIEF DESCRIPTION OF DRAWINGS

FIG. 1 is a cross-sectional view illustrating an overall configuration of a vibration device according to an embodiment of a technology of the present disclosure.

FIG. 2 is a block diagram illustrating a configuration of a control unit of the vibration device according to the embodiment of the technology of the disclosure.

FIG. 3A is a cross-sectional view illustrating a configuration of a voice coil type actuator of the vibration device according to the embodiment of the technology of the disclosure.

FIG. 3B is a schematic view illustrating a configuration of the voice coil type actuator of the vibration device according to the embodiment of the technology of the disclosure.

FIG. 4 is a diagram illustrating an example of a control signal that is a composite wave obtained by combining a plurality of sine waves.

### DESCRIPTION OF EMBODIMENTS

Hereinafter, embodiments of the technology of the present disclosure will be described in detail with reference to the drawings.

### <Configuration of Vibration Device According to Embodiment of Technology of Present Disclosure>

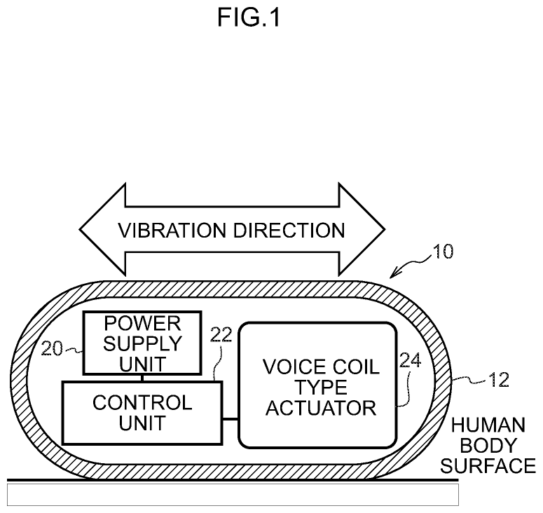

FIG. 1 is a cross-sectional view of a vibration device 10 according to an embodiment of a technology of the disclosure. As illustrated in FIG. 1, the vibration device 10 includes a power supply unit 20, a control unit 22, and a voice coil type actuator 24 in a housing 12.

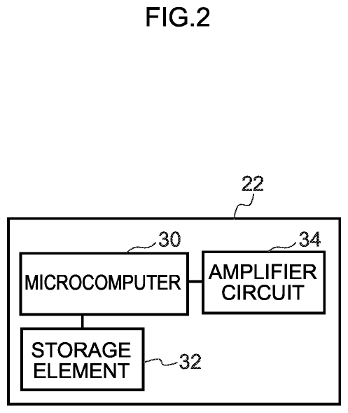

As illustrated in FIG. 2, the control unit 22 includes a microcomputer 30, a storage element 32, and an amplifier circuit 34.

The voice coil type actuator 24 vibrates in a vibration direction according to a control signal output from the control unit 22, thereby applying vibration to a human body surface and massaging a human body. The vibration direction is, for example, a direction substantially parallel to a contact surface with the human body.

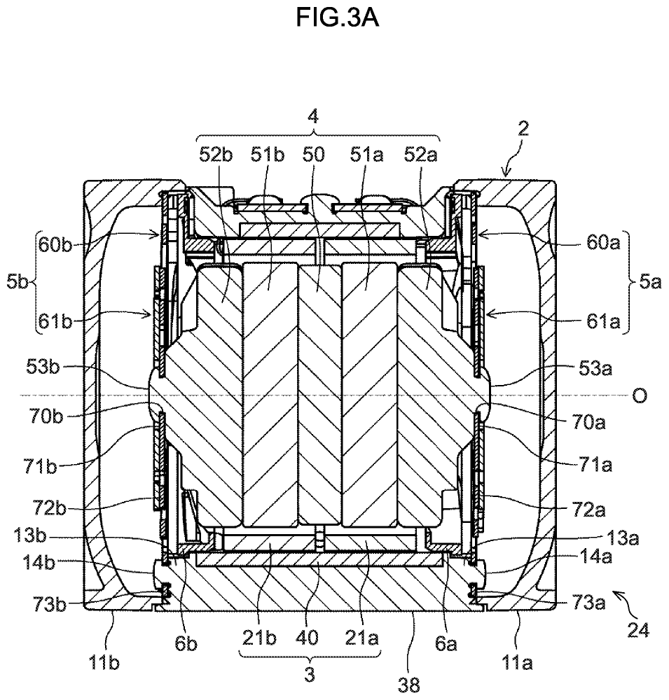

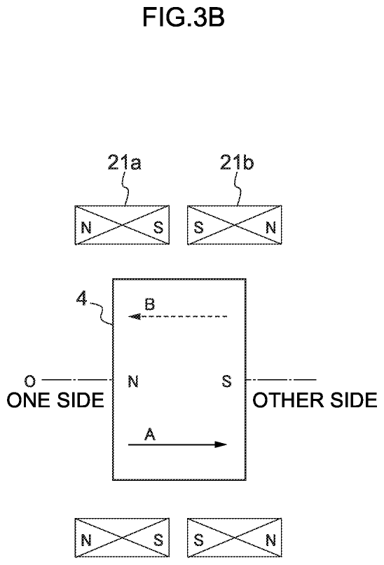

As illustrated in FIG. 3A, the voice coil type actuator 24 mainly includes a case 2 forming an outer shell, an electromagnetic drive unit 3, a movable element 4, a first support unit 5a, a second support unit 5b, a first inner guide 6a, and a second inner guide 6b. The electromagnetic drive unit 3 is provided in the case 2. The movable element 4 is configured to be vibratable by electromagnetic drive unit 3. The first support unit 5a and the second support unit 5b elastically support both ends of the movable element 4. The first inner guide 6a and the second inner guide 6b restrict the movement of the first support unit 5a and the second support unit 5b.

In the case 2, both open ends of a cylindrical case body are closed by a first cover case 11a and a second cover case 11b.

The electromagnetic drive unit 3 includes a yoke 40 that is disposed inside the case 2 and is made of a cylindrical soft magnetic material, and a first coil 21a and a second coil 21b that are attached to an inner surface of the yoke 40 in a state of being electrically insulated from the yoke 40.

The first coil 21a and the second coil 21b are wound along the inner surface of the yoke 40. Each of the first coil 21a and the second coil 21b can generate a magnetic field by energization from a terminal.

The movable element 4 is surrounded by first coil 21a and second coil 21b, and disposed so as to vibrate along vibration axis O. The movable element 4 includes a disk-shaped magnet 50, a disk-shaped first pole piece 51a and second pole piece 51b arranged so as to sandwich the magnet 50, and a first mass (weight) 52a and a second mass (weight) 52b arranged so as to sandwich the magnet 50, the first pole piece 51a, and the second pole piece 51b.

A magnetization direction of the magnet 50 is a direction of a vibration axis O. The first pole piece 51a and the second pole piece 51b are made of a soft magnetic material, and are attached to the magnet 50 by a magnetic attraction force of the magnet 50, an adhesive, and the like. The first mass 52a and the second mass 52b are made of a non-magnetic material, and are respectively attached to the first pole piece 51a and the second pole piece 51b with an adhesive or the like. Therefore, the magnet 50, the first pole piece 51a, the second pole piece 51b, the first mass 52a, and the second mass 52b constituting the movable element 4 are integrated. In the first mass 52a and the second mass 52b, contact surfaces with the first pole piece 51a and the second pole piece 51b are formed flat. The surface opposite to the contact surface is formed in a spiral shape in which the vibration axis O is set as the central axis and tip portions 53a and 53b on the central axis protrude most outward.

In the movable element 4 configured as described above, both end portions in the direction of the vibration axis O, that is, tip portions 53a and 53b of the first mass 52a and the second mass 52b are supported by the first support unit 5a and the second support unit 5b, respectively.

The first support unit 5a includes a first damper 60a (first leaf spring) and a first elastic member 61a provided on one surface of the first damper 60a.

In the first damper 60a, a support portion 71a having a hole 70a is formed in a central portion. The first damper 60a is connected to the movable element 4 through the hole 70a. Specifically, the tip portion 53a of the first mass 52a is inserted into the hole 70a, and the tip portion 53a is swaged by being crushed.

The first damper 60a has three arm portions 72a spirally extending from the support portion 71a to the outer periphery. The arm portions 72a are formed at equal intervals at a pitch of 120° around the vibration axis O. An outer peripheral end of each arm portion 72a is connected to an annular frame portion 73a along the inner surface of the case body. The frame portion 73a is connected by flange portions 13a protruding radially inward at three positions on the inner surface of the case body at a pitch of 120° around the vibration axis O.

The first damper 60a includes one or a plurality of metal leaf springs, and for example, in the present embodiment, a thin plate made of stainless steel (spring material) is used. The material of the first damper 60a is not limited to metal, and may be a composite material containing resin or fiber. A material that is resistant to fatigue and excellent in flexibility is desirable.

The first damper 60a configured as described above is elastically deformable within a predetermined range in an intersecting direction including the direction of the vibration axis O and the radial direction perpendicular to the vibration axis O. This predetermined range corresponds to an amplitude range of movable element 4 in a case where movable element 4 is normally used as voice coil type actuator 24. Therefore, the predetermined range is a range in which at least the first damper 60a does not come into contact with the case 2, and is a range that does not exceed a limit of elastic deformation of the first damper 60a.

The first elastic member 61a has a plate shape having an outer shape along a shape from the support portion 71a of the first damper 60a to a certain range of each arm portion 72a, and is fixed to one surface of the first damper 60a. Damping of the first damper 60a is performed by elastic deformation of the first elastic member 61a.

The second support unit 5b also has the same configuration as the first support unit 5a, and includes a second damper 60b (second leaf spring) and a second elastic member 61b. In the present embodiment, the second damper 60b and the first damper 60a have the same shape and the same material, and the second elastic member 61b and the first elastic member 61a have the same shape and the same material. The three arm portions 72b of the second damper 60b extend from the support portion 71b in which the hole 70b is formed to the annular frame portion 73b. The second damper 60b is connected to the movable element 4 by inserting the tip portion 53b of the second mass 52b into the hole 70b, crushing, and swaging. The second damper 60b is connected to the three flange portions 13b in which the annular frame portion 73b protrudes from the inner surface of the case body, by inserting the boss portion 14b of the flange portion 13b through the through hole formed in the frame portion 73b, crushing, and swaging. The spiral direction of each arm 72b of the second damper 60b is opposite to the spiral direction of each arm 72a of the first damper 60a. As a result, the movable element 4 receives the torque in the opposite direction from the first damper 60a and the second damper 60b at the time of vibration, and thus does not rotate about the vibration axis O even when the movable element 4 is displaced in the direction of the vibration axis O.

The first inner guide 6a is provided on one side in the direction of the vibration axis O of the voice coil type actuator 24 and on the other side (center side of the case 2) in the direction of the vibration axis O with respect to the first support unit 5a. The second inner guide 6b is provided on the other side in the direction of the vibration axis O of the voice coil type actuator 24, and is provided on one side (center side of the case 2) in the direction of the vibration axis O with respect to the second support unit 5b. That is, the first inner guide 6a and the second inner guide 6b are provided on the center side in the direction of the vibration axis O with respect to the first support unit 5a and the second support unit 5b in the case 2.

As illustrated in FIG. 3B, in the voice coil type actuator 24, in a state in which the first coil 21a and the second coil 21b are not energized, the movable element 4 supported by the first damper 60a and the second damper 60b is located at the centers of the first coil 21a and the second coil 21b.

When the movable element 4 is vibrated, alternating current is applied to the first coil 21a and the second coil 21b in directions in which magnetic fields of opposite polarities are alternately generated. That is, the same polarity is generated in adjacent portions of the first coil 21a and the second coil 21b.

For example, in the case of the polarity illustrated in FIG. 3B, thrust toward the other side (the right side in FIG. 3B) in the direction of the vibration axis O indicated by a solid arrow A is generated in the movable element 4, and when the current flowing to the first coil 21a and the second coil 21b is reversed, thrust toward one side (the left side in FIG. 3B) in the direction of the vibration axis O indicated by a dotted arrow B is generated in the movable element 4.

In this manner, when alternating current is applied to the first coil 21a and the second coil 21b, the movable element 4 vibrates along the vibration axis O while receiving biasing forces of the first damper 60a and the second damper 60b from both sides.

The storage element 32 stores data of a reference waveform of one cycle which is a sine wave for a plurality of frequencies.

Each frequency of the reference waveform is set to a frequency close to the resonance frequency of the voice coil type actuator 24.

The microcomputer 30 outputs a control signal to voice coil type actuator 24 so as to vibrate the voice coil type actuator 24 in a vibration direction substantially parallel to the contact surface with the human body by using data of reference waveforms of a plurality of frequencies stored in storage element 32. This control signal is a composite wave obtained by combining a plurality of sine waves, and is a control signal in which a difference between frequencies of the plurality of sine waves is a specific frequency.

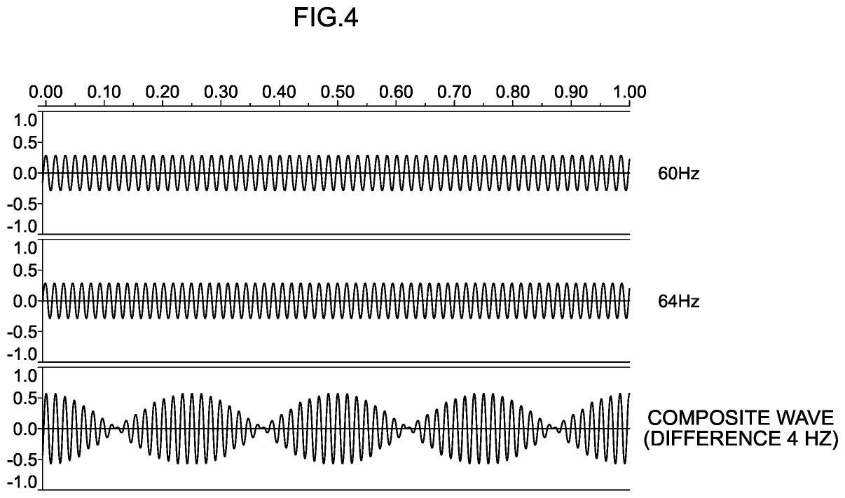

Specifically, the microcomputer 30 generates a sine wave that is a reference waveform for each of the plurality of frequencies, and generates a control signal that is a composite wave obtained by combining the sine waves of the plurality of frequencies (FIG. 4). FIG. 4 illustrates an example in which a sine wave having a frequency of 60 Hz and a sine wave having a frequency of 64 Hz are combined to generate a composite wave having a frequency component of 4 Hz, which is the frequency of the difference, as a waviness. In this example, the resonance frequency of voice coil type actuator 24 is 65 Hz.

It is possible to change a combination of two frequencies among a plurality of frequencies of the reference waveform, and it is possible to combine sine waves of the changed combination of frequencies to generate a composite wave having a frequency component of a frequency of a difference.

### <Operation of Vibration Device According to Embodiment of Technology of Present Disclosure>

The vibration device 10 is built in a cavity portion of a massager (not illustrated), and a user attaches the massager to a surface of a human body of a site to be massaged using a restraint member (not illustrated), and turns on a switch of the vibration device 10 by a remote operation such as a remote controller. The control unit 22 outputs the control signal to the voice coil type actuator 24 so as to vibrate the voice coil type actuator 24 in a vibration direction substantially parallel to the contact surface with the human body. The control signal is a composite wave obtained by combining sine waves of a plurality of frequencies, and a difference between the plurality of frequencies is the specific frequency.

In this case, the voice coil type actuator 24 can apply low-frequency vibration, which is the difference between the plurality of frequencies, to the human body.

When the user changes a specific low frequency given to the human body by a remote operation such as a remote control, a control signal which is a composite wave obtained by combining sine waves of a plurality of frequencies having the specific low frequency as a frequency difference is output to the voice coil type actuator 24.

As described above, by changing the specific low frequency, it is possible to give comfortable vibration having different effects to the human body.

### Experimental Results

A result of an experiment performed to evaluate an effect of applying vibration to a subject by the vibration device described in the above embodiment will be described.

After a subject was vibrated with the existing massager equipped with an eccentric motor, the subject was vibrated with four kinds of control signals illustrated in the following table using the vibration device described in the above embodiment, and the subject was subjectively evaluated for quality compared with the existing massager.

TABLE 1

| No. | Signal waveform |
|---|---|
| 1 | Sine wave 60 Hz |
| 2 | Sine wave 100 Hz |
| 3 | Sine wave 160 Hz |
| 4 | Sine wave composite 60 + 64 Hz |

As illustrated in the above table, four types of control signals include a control signal that is a sine wave of 60 Hz, a control signal that is a sine wave of 100 Hz, a control signal that is a sine wave of 160 Hz, and a control signal that is a composite wave obtained by combining a sine wave of 60 Hz and a sine wave of 64 Hz.

The subjects were three women in their twenties. The three subjects frequently used the existing massager and were familiar with the vibration experience. The subject is not notified of the purpose of the design of the signal in advance. On another day, bodily sensation and evaluation in another room were performed.

As a result, all three subjects evaluated the vibration experience by the vibration device as favorable. One of the subjects evaluated the No. 4 control signal as having “organic” experience and having a relaxing effect.

As described above, the vibration device according to the embodiment of the technology of the disclosure outputs the control signal, which is the composite wave obtained by combining the plurality of sine waves having different frequencies and in which the difference between frequencies of the plurality of sine waves is a specific frequency, to the vibrating body. As a result, comfortable vibration can be given to the human body.

By using two sine waves close to the resonance frequency, energy efficiency is improved, that is, vibration stimulation is increased.

Since it is difficult to control a small voice coil type actuator at a low frequency band, in the embodiment of the technology of the disclosure, the voice coil type actuator is controlled using a difference between two waveforms. That is, the small voice coil type actuator does not vibrate with the control signal of the sine wave of 4 Hz, but the voice coil type actuator vibrates when the control is performed at the difference (64 Hz-60 Hz=4 Hz) between the frequencies 60 Hz and 64 Hz of the sine wave. Here, the “low band frequency” is, for example, 50 Hz or less. However, the present invention is not limited to this numerical value.

The frequency difference can be changed by changing the combination of the frequencies of the sine waves to be combined, and the influence on the human body by the vibration of the low frequency can be changed.

In the embodiment of the technology of the disclosure, since the voice coil type actuator is used, control in a wide frequency band is possible. It is possible to vibrate with a composite wave obtained by combining sine waves of a plurality of frequencies at the same time. This makes it possible to simultaneously stimulate different human bodies. Specifically, Pacinian corpuscles are likely to be stimulated at a frequency of 100 Hz or more, and Meissner corpuscles are likely to be stimulated at a frequency of 100 Hz or less. Therefore, by applying vibration with the control signal in which sine waves of these frequencies are combined, it is possible to simultaneously stimulate different corpuscles of the human body.

In the voice coil type actuator, dampers (leaf springs) are provided in pairs. As a result, low-frequency vibration is easily generated, that is, low-frequency vibration is easily controlled.

The voice coil type actuator is configured as a cylinder type (column type). As a result, the voice coil type actuator has a shape suitable for low-frequency vibration.

The movable element of the voice coil type actuator is provided with a magnet, a yoke, and a weight. As a result, a suitable magnetic flux and weight can be obtained, and optimum vibration can be obtained.

The control unit outputs the control signal, which is the composite wave obtained by combining a plurality of sine waves having different frequencies so as to vibrate the vibrating body according to the control signal and in which the difference between frequencies of the plurality of sine waves is a specific frequency, to the vibrating body. Here, the specific frequency is a frequency corresponding to an effect to be given to the human body by comfortable vibration. By outputting this signal to the vibrating body, comfortable vibration can be given to the human body.

The frequency of each of the plurality of sine waves according to the technology disclosed above is a frequency corresponding to a resonance frequency of the vibrating body. As a result, the vibrating body can be efficiently vibrated. Here, the “corresponding frequency” may be a frequency corresponding to the resonance frequency to such an extent that the vibration stimulation is felt by the human body. For example, the resonance frequency may be about ±20 Hz, but is not limited to this value.

The technology of the disclosure is not limited to the above-described embodiments, and various modifications and applications can be made without departing from the gist of the technology of the present disclosure.

For example, in the above-described embodiment, the case where the voice coil type actuator is used as the vibrating body has been described as an example, but the present invention is not limited thereto, and an actuator other than the voice coil type actuator may be used. For example, a solenoid, a linear actuator, or the like is included.

The technology of the disclosure can also be used in an electric beauty device using vibration. For example, a facial brush, a facial massager, and the like are included.

The disclosure of Japanese Patent Application No. 2021-057387 is incorporated herein by reference in its entirety.

All documents, patent applications, and technical standards described in this specification are incorporated herein by reference to the same extent as if each individual document, patent application, and technical standard were specifically and individually described to be incorporated by reference.

1. A vibration device comprising:
a vibrating body that applies vibration to a human body; and
a control unit that outputs a control signal to the vibrating body so as to vibrate the vibrating body according to the control signal, the control signal being a composite wave obtained by combining a plurality of sine waves having different frequencies, and a difference between frequencies of the plurality of sine waves being a specific frequency.

2. The vibration device according to claim 1, wherein the frequency of each of the plurality of sine waves is a frequency corresponding to a resonance frequency of the vibrating body.

3. The vibration device according to claim 1, wherein the vibrating body is an actuator.

4. The vibration device according to claim 3, wherein the vibrating body is a voice coil type actuator, a solenoid, or a linear actuator.

5. The vibration device according to claim 1, wherein the vibrating body applies vibration for massaging the human body.
